(19) United States
(12) Patent Application Publication
(10) Pub. No.: US 2017/0278478 A1
(43) Pub. Date: Sep. 28, 2017

(54) DISPLAY METHOD AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Shuai XU, Beijing (CN); Zhiyong WANG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/277,124

(22) Filed: Sep. 27, 2016

(30) Foreign Application Priority Data
Mar. 23, 2016 (CN) 201610169020.0

(51) Int. Cl. G09G 5/00; G06F 3/0488; G09G 5/14

(52) U.S. Cl. CPC G09G 5/005; G09G 5/14; G06F 3/04883; G09G 2300/026; G09G 2360/04

(57) ABSTRACT

A display method and a display device are provided. The display method is used for the display device, and a display screen of the display device includes a plurality of display areas. The display method includes a step of, in the case that one or more display areas are failed, displaying, at display areas that are not failed, an image to be displayed on the display screen.

### CROSS-REFERENCE TO RELATED APPLICATIONS

This application claims priority to Chinese application No. 201610169020.0, filed Mar. 23, 2016, which is hereby incorporated by reference in its entirety.

### TECHNICAL FIELD

The present disclosure relates to the field of display technology, in particular to a display method and a display device.

### BACKGROUND

For a conventional display device, in the case that some hardware having a display function is failed, an image may not be displayed normally at parts of areas of a display screen. Especially, in the case that some important contents, such as a rear view image for parking and an image for futures trading, are being displayed, the failure of the hardware may cause large losses to users at any time.

Hence, there is an urgent need to find out a scheme for helping the user to view all images even in the case of the failure at some areas of the display screen, thereby to enable the user to acquire sufficient information and prevent the possible losses.

### SUMMARY

An object of the present disclosure is to display an entire image normally in the case of a failure at a part of display areas on a display screen.

In one aspect, the present disclosure provides in some embodiments a display method for use in a display device, a display screen of the display device including a plurality of display areas. The display method includes a step of, in the case that one or more display areas are failed, displaying, at display areas that are not failed, an image to be displayed on the display screen.

Optionally, the step of displaying, at the display areas that are not failed, the image to be displayed on the display screen includes: selecting a rectangular display area including a plurality of adjacent display areas from all display areas that are not failed; and displaying, at the rectangular display area, the image to be displayed on the display screen.

Optionally, the step of selecting the rectangular display area including the plurality of adjacent display areas from all the display areas that are not failed includes, in the case that there is a plurality of rectangular display areas, selecting a rectangular display area with a maximum area.

Optionally, the display screen is a touch display screen, and the step of selecting the rectangular display area including the plurality of adjacent display areas from all the display areas that are not failed further includes: acquiring a predetermined touch operation with a sliding direction made by a user with respect to the display area that is failed; and selecting a rectangular display area including a plurality of adjacent display areas and pointed by the predetermined touch operation from the display areas that are not failed.

Optionally, the predetermined touch operation includes multi-point sliding operations having a substantively same sliding direction.

Optionally, in the display device, a data line for each display area is driven by a corresponding data integrated circuit (IC), and a gate line for each display area is driven by a corresponding gate IC. The display method further includes, prior to displaying the image to be displayed on the display screen, enabling the data ICs and the gate ICs corresponding to the plurality of selected display areas included in the rectangular display area, and disabling the other data ICs and gate ICs.

Optionally, the step of displaying, at the display areas that are not failed, the image to be displayed on the display screen includes: selecting a valid display area including a plurality of adjacent display areas from all the display areas that are not failed; and displaying, at the valid display area, the image to be displayed on the display screen.

In another aspect, the present disclosure further provides a display device, including a display screen including a plurality of display areas. The display device further includes an image processing module configured to, in the case that one or more display areas are failed, displaying, at display areas that are not failed, an image to be displayed on the display screen.

Optionally, the image processing module includes: a selection sub-module configured to select a rectangular display area including a plurality of adjacent display areas from all display areas that are not failed; and a display sub-module configured to display, at the rectangular display area, the image to be displayed on the display screen.

Optionally, the selection sub-module includes an active selection unit configured to, in the case that there is a plurality of rectangular display areas, select a rectangular display area with a maximum area.

Optionally, the display screen is a touch display screen, and the selection sub-module further includes a passive selection unit configured to acquire a predetermined touch operation with a sliding direction made by a user with respect to the display area that is failed, and select a rectangular display area including a plurality of adjacent display areas and pointed by the predetermined touch operation from the display areas that are not failed.

Optionally, a data line for each display area is driven by a corresponding data IC, and a gate line for each display area is driven by a corresponding gate IC. The image processing module further includes a switch sub-module configured to, prior to displaying the image to be displayed on the display screen, enable the data ICs and the gate ICs corresponding to the plurality of selected display areas included in the rectangular display area, and disable the other data ICs and gate ICs.

Optionally, the image processing module includes: a selection sub-module configured to select a valid display area including a plurality of adjacent display areas from all the display areas that are not failed; and a display sub-module configured to display, at the valid display area, the image to be displayed on the display screen.

According to the embodiments of the present disclosure, in the case that a part of the display areas of the display screen are failed, it is able to compensate for the image to be displayed on the display screen, i.e., to display the image to be display on the display screen at the display area that is not failed. As a result, it is able for the user to acquire all the image information in time, thereby to prevent the secure and property losses.

### DESCRIPTION OF THE DRAWINGS

FIGS. 1A-1D are schematic views showing situations where an image to be displayed on a display screen is displayed at selected rectangular display areas using a display method according to at least one embodiment of the present disclosure;

FIG. 2 is a schematic view showing a situation where the rectangular display area is selected by the user through a touch operation using the display method according to at least one embodiment of the present disclosure; and

FIGS. 3A-3C are schematic views showing a situation where an image to be displayed on the display screen is displayed at a selected rectangular display area by changing operation states of data ICs and gate ICs using the display method according to at least one embodiment of the present disclosure;

FIG. 4A is a schematic view showing a display device according to at least one embodiment of the present disclosure; and

FIG. 4B is a schematic view showing an image processing module according to at least one embodiment of the present disclosure.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

The present disclosure will be described hereinafter in conjunction with the drawings and embodiments. The following embodiments are for illustrative purposes only, but shall not be used to limit the scope of the present disclosure.

The present disclosure aims to enable a user to view an entire image on a display screen in the case that a part of display areas are failed.

The present disclosure provides in some embodiments a display method for use in a display device, and a display screen of the display device includes a plurality of display areas. The display method includes Step 1 of, in the case that one or more display areas are failed, displaying, at display areas that are not failed, an image to be displayed on the display screen.

According to the display method in the embodiments of the present disclosure, in the case that a part of the display areas of the display screen are failed, it is able to compensate for the image to be displayed on the display screen, i.e., to display the image to be display on the display screen at the display areas that are not failed. As a result, it is able for the user to acquire all the image information in time, thereby to prevent the secure and property losses.

To be specific, an image is displayed at a rectangular display area of a conventional display screen, so in Step 1, a rectangular display area including a plurality of adjacent display areas may be selected from all the display areas that are not failed, so as to display the image.

The schemes for selecting the rectangular display area will be described hereinafter illustratively.

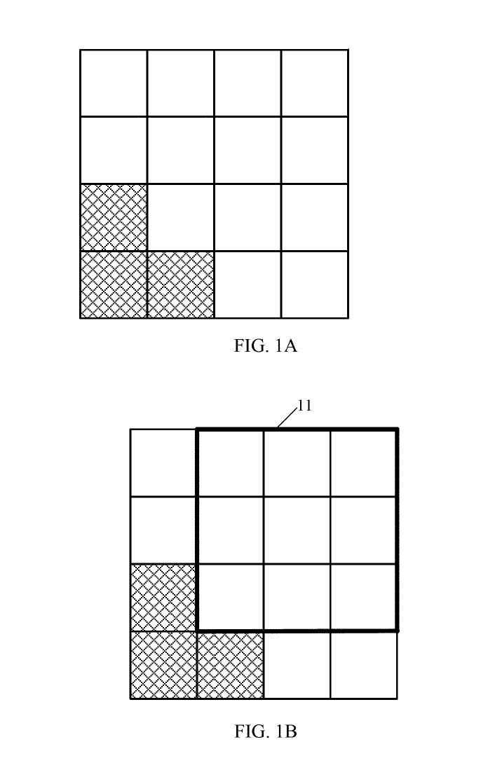

Referring to FIG. 1A, the display screen includes 4*4 display areas (i.e., the smallest rectangles in FIG. 1A). In the case that three display areas at a lower left corner are failed and cannot be used to display an image (i.e., hatched rectangles in FIG. 1A), rectangular display areas 11 in FIGS. 1B-1D may be selected on the display screen, so as to display the image.

Of course, it should be appreciated that, in the embodiments of the present disclosure, the entire image to be displayed on the display screen is displayed at the selected rectangular display area, so the resultant image may be scaled down to some extent. Optionally, in the case that there is a plurality of rectangular display areas on the display screen, a rectangular display area with a maximum area may be selected, so as to ensure the user to view contents in the image clearly.

For example, for the rectangular display areas 11 in FIGS. 1B to 1D, obviously the rectangular display area 11 in FIG. 1B has the maximum area. In the case of the failure as shown in FIG. 1A, the rectangular display area 11 in FIG. 1B may be selected to display the image.

Of course, the above scheme of selecting the rectangular display area may be executed automatically through a program. In other words, in the case that a part of the display areas are failed, in the embodiments of the present disclosure, the rectangular display area with the maximum area may be selected automatically to display the image, thereby to ensure the user to acquire information in time.

However, in some special scenarios, the automatically-selected rectangular display area 11 with the maximum area may not be a desired display area. For example, in the case of a failure of a vehicle-mounted terminal, the automatically-selected rectangular display area may be located far away from a driver, and at this time, the driver may view an image at an inconvenient angle.

In order to prevent the above drawback, the display method in the embodiments of the present disclosure further includes a step of passively selecting the rectangular display area, which will be described hereinafter.

In the embodiments of the present disclosure, the desired rectangular display area may be selected by the user (e.g., through a touch operation), and at this time, the display screen may be a touch display screen.

The step of selecting the rectangular display area including the plurality of adjacent display areas includes: acquiring a predetermined touch operation with a sliding direction made by a user with respect to the display area that is failed; and selecting a rectangular display area including a plurality of adjacent display areas and pointed by the predetermined touch operation from the display areas that are not failed.

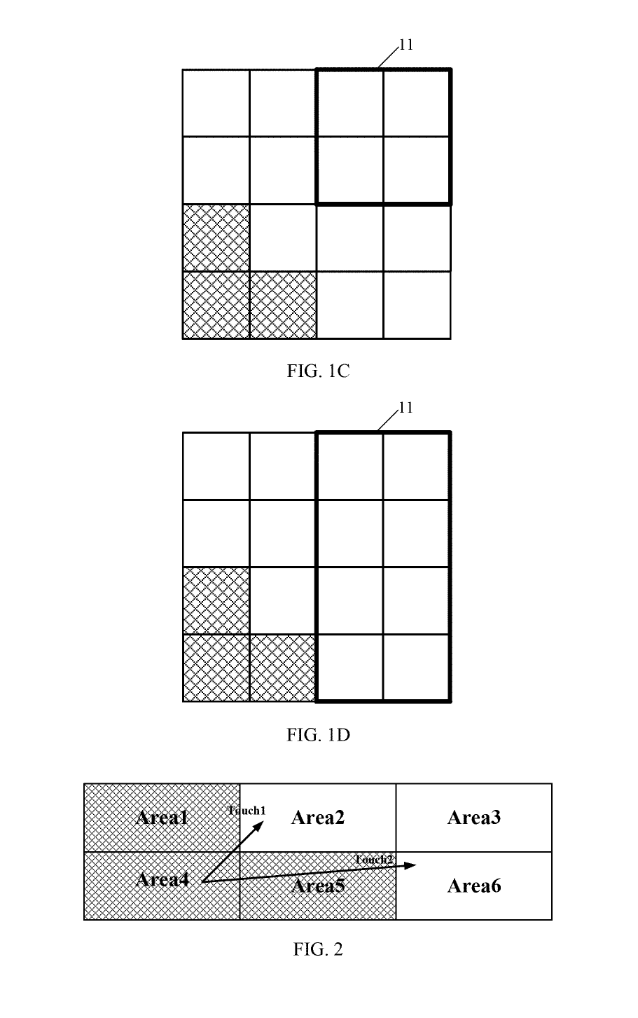

For example, as shown in FIG. 2, the touch display screen includes 6 display areas, i.e., Area 1 to Area 6. In the case of failures at Area 1, Area 4 and Area 5, the user may perform the predetermined touch operations Touch 1 and Touch 2 with two different sliding directions at Area 1, Area 4 and Area 5.

In the case that the user performs the predetermined touch operation Touch 1, it may be determined, in accordance with a sliding direction of Touch 1, that a rectangular display area including Area 2 and Area 3 may be desired to be selected by the user to display the image. Similarly, in the case that the user performs the predetermined touch operation Touch 2, it may be determined, in accordance with a sliding direction of Touch 2, that a rectangular display area including Area 3 and Area 6 may be desired to be selected by the user to display the image.

In this way, the user may select the rectangular display area for displaying the image at a desired position merely through the touch operation. The entire scheme is convenient at a user side, and thus has high practical applicability.

Of course, in a normal scenario, in order to prevent the image from being displayed at a part of display areas due to an operational error, the predetermined touch operation may be a multi-point sliding operation having substantially the same sliding direction, which may be different from any other touch operation commonly used in the art. For example, the image compensation may be performed only in the case that the user makes a sliding operation at the display area that is failed with two fingers.

The principle of the image compression will be described hereinafter in more details.

For a conventional display device, a display screen includes pixels arranged in an array form, and each pixel is used to perform an image display in accordance with signals applied to a corresponding gate line and a corresponding data line.

In the embodiments of the present disclosure, each display area may include one or more pixels. All data lines at each display area are driven by a corresponding data IC, and all gate lines at each display area are driven by a corresponding gate IC.

In the embodiments of the present disclosure, before displaying the image to be displayed on the display screen, the data ICs and the gate ICs corresponding to the rectangular display area may enabled, and the other data ICs and the gate ICs may be disabled. In this way, it is able to prevent the signals from being applied to the data lines and gate lines at the display region that is failed, and instead, the image is only displayed at the selected rectangular display area.

During the actual application, each data IC and gate IC may be switched between an operation state and a non-operation state. In the embodiments of the present disclosure, it is able to enable or disable the data IC or gate IC merely switching it between the two states.

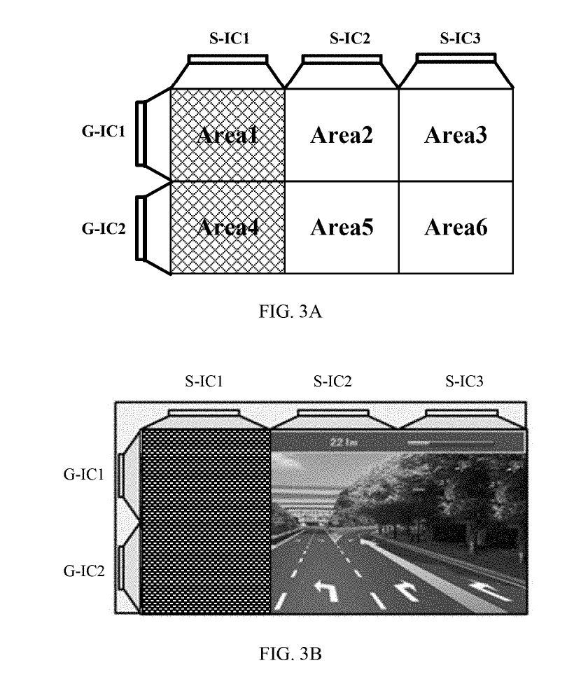

For example, as shown in FIG. 3A, the display screen includes display areas Area 1 to Area 6. The data lines for the display areas in a column direction may be driven by the data ICs S-IC1 to S-IC3, and the gate lines for the display areas in a row direction may be driven by the gate ICs G-IC1 to G-SC2.

In the case of the failures at Area 1 and Area 4, a rectangular display area including Area 2, Area 3, Area 5 and Area 6 may be selected as mentioned above, so as to display the entire image. At this time, merely the data ICs S-IC2 and S-IC3 and the gate ICs G-IC1 and G-IC2 corresponding to Area 2, Area 3, Area 5 and Area 6 may be enabled, while the data IC S-IC1 may be disabled.

FIG. 3B shows the image displayed on the display screen in the case that all the data ICs and gate ICs are enabled, where the corresponding image may not be displayed at Area 1 and Area 4 that are failed. FIG. 3C shows the image displayed at Area 2, Area 3, Area 5 and Area 6 in a compressed manner after the data ICs and the gate ICs are controlled as mentioned above, where the complete image information may be viewed by the user.

In a word, the display method in the embodiments of the present disclosure has the following advantages. 1) In the case that a part of areas of the display screen are failed, the entire image may be displayed at the display areas that are not failed, so that the user may acquire the complete image information. 2) In the case of the failures at a part of the display areas, the display area may be selected in two modes, i.e., an active mode and a passive mode, so as to improve the user experience. 3) The display area for displaying the entire image may be selected merely through switching the operation states of the data ICs and the gate ICs at a hardware side. In the case that the display device is a smart terminal and any application on the display device is used by the user, the image compensation scheme may be applied, because no change is made to the applications.

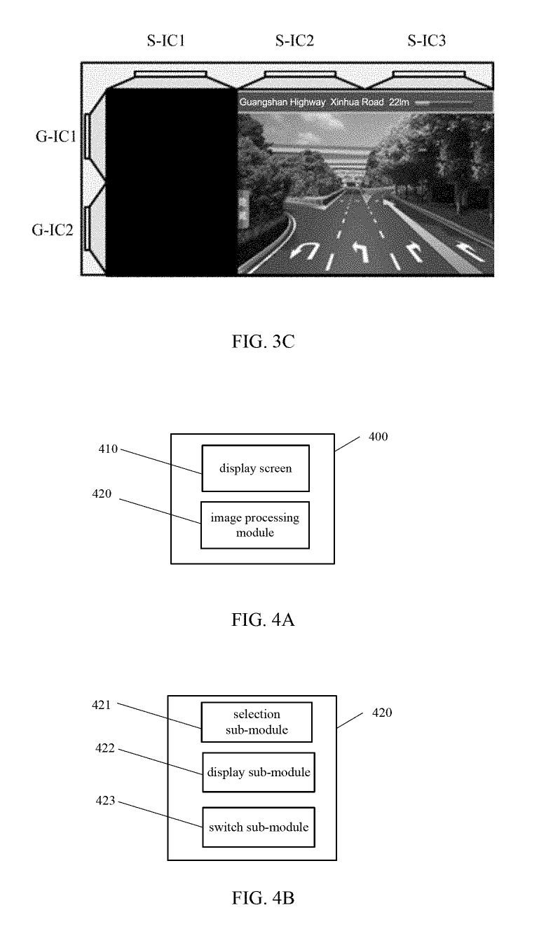

As shown in FIG. 4A, the present disclosure further provides in some embodiments a display device 400 including a display screen 410 including a plurality of display areas. The display device further includes an image processing module 420 configured to, in the case that one or more display areas are failed, displaying, at display areas that are not failed, an image to be displayed on the display screen

To be specific, as shown in FIG. 4B, the image processing module 420 includes: a selection sub-module 421 configured to select a rectangular display area including a plurality of adjacent display areas from all display areas that are not failed; and a display sub-module 422 configured to display, at the rectangular display area, the image to be displayed on the display screen.

In the embodiments of the present disclosure, the rectangular display area including a plurality of adjacent normal display areas, rather than all the normal display areas, is used to display the entire image, so as to meet the current requirement of rectangular display.

Further, in the case of a failure of the display screen, a rectangular display area may be selected automatically, or the user may select the desired rectangular display area, so as to display the entire image.

In the case that the rectangular display area is selected automatically, the selection sub-module includes an active selection unit configured to, in the case that there is a plurality of rectangular display areas, select a rectangular display area with a maximum area for displaying the entire image.

In the embodiments of the present disclosure, the active selection unit may select the rectangular display area with the maximum area to display the entire image, so as to ensure the user to view contents of the image clearly, thereby to improve the user experience.

In addition, in the case that the rectangular display area is selected in the passive mode, the selection sub-module includes a passive selection unit configured to acquire a predetermined touch operation with a sliding direction made by a user with respect to the display area that is failed, and select a rectangular display area including a plurality of adjacent display areas and pointed by the predetermined touch operation from the display areas that are not failed.

During the actual application, an instruction set for the predetermined touch operations may be stored in the display device, and once the predetermined touch operation is made by the user and detected by the passive selection unit, a corresponding instruction in the instruction set may be called to select the rectangular display area.

In addition, in a normal scenario, in order to prevent the image from being displayed at a part of display areas due to an operational error, the predetermined touch operation may be a multi-point sliding operation having the substantively same sliding direction, which may be different from any other touch operation commonly used in the art.

To be specific, a data line for each display area is driven by a corresponding data IC, and a gate line for each display area is driven by a corresponding gate IC. The image processing module further includes a switch sub-module 423 configured to, prior to displaying the image to be displayed on the display screen, enable the data ICs and the gate ICs corresponding to the plurality of selected display areas included in the selected rectangular display area, and disable the other data ICs and gate ICs.

It should be appreciated that, the valid display area of any other shapes may also be used, as long as the entire image may be displayed. In other words, the valid display region of any other shapes shall also fall within the scope of the present disclosure.

In the embodiments of the present disclosure, the entire image may be displayed at a part of the normal display areas, merely through switching the operation state of a part of the data ICs and gate ICs at a hardware side. During the actual application, the display device may be a smart terminal such as a mobile phone, a flat-panel computer or a vehicle-mounted system. Because of no change in any application on the smart terminal, the user may perform the image compensation scheme in the case that any application is being used.

Obviously, the implementation of the display device may refer to that of the display method, so it may achieve the same technical effects.

The above are merely the preferred embodiments of the present disclosure. Obviously, a person skilled in the art may make further modifications and improvements without departing from the spirit of the present disclosure, and these modifications and improvements shall also fall within the scope of the present disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A display method, used in a display device, a display screen of the display device comprising a plurality of display areas, the display method comprising a step of, in the case that one or more display areas are failed, displaying, at display areas that are not failed, an image to be displayed on the display screen.

2. The display method according to claim 1, wherein the step of displaying, at the display areas that are not failed, the image to be displayed on the display screen comprises:
selecting a rectangular display area including a plurality of adjacent display areas from all display areas that are not failed; and
displaying, at the rectangular display area, the image to be displayed on the display screen.

3. The display method according to claim 2, wherein the step of selecting the rectangular display area including the plurality of adjacent display areas from all the display areas that are not failed comprises, in the case that there is a plurality of rectangular display areas, selecting a rectangular display area with a maximum area.

4. The display method according to claim 2, wherein the display screen is a touch display screen, and
the step of selecting the rectangular display area including the plurality of adjacent display areas from all the display areas that are not failed further comprises:
acquiring a predetermined touch operation with a sliding direction made by a user with respect to the display area that is failed; and
selecting a rectangular display area including a plurality of adjacent display areas and pointed by the predetermined touch operation from the display areas that are not failed.

5. The display method according to claim 4, wherein the predetermined touch operation comprises multi-point sliding operations having a substantively same sliding direction.

6. The display method according to claim 2, wherein in the display device, a data line for each display area is driven by a corresponding data integrated circuit (IC), a gate line for each display area is driven by a corresponding gate IC, and the display method further comprises, prior to displaying the image to be displayed on the display screen, enabling the data ICs and the gate ICs corresponding to the plurality of selected display areas included in the rectangular display area, and disabling the other data ICs and gate ICs.

7. The display method according to claim 1, wherein the step of displaying, at the display areas that are not failed, the image to be displayed on the display screen comprises: selecting a valid display area including a plurality of adjacent display areas from all the display areas that are not failed; and displaying, at the valid display area, the image to be displayed on the display screen.

8. A display device, comprising a display screen including a plurality of display areas, wherein the display device further comprises an image processing module configured to, in the case that one or more display areas are failed, displaying, at display areas that are not failed, an image to be displayed on the display screen.

9. The display device according to claim 8, wherein the image processing module comprises:
a selection sub-module configured to select a rectangular display area including a plurality of adjacent display areas from all display areas that are not failed; and
a display sub-module configured to display, at the rectangular display area, the image to be displayed on the display screen.

10. The display device according to claim 9, wherein the selection sub-module comprises an active selection unit configured to, in the case that there is a plurality of rectangular display areas, select a rectangular display area with a maximum area.

11. The display device according to claim 9, wherein the display screen is a touch display screen, and the selection sub-module further comprises a passive selection unit configured to acquire a predetermined touch operation with a sliding direction made by a user with respect to the display area that is failed, and select a rectangular display area including a plurality of adjacent display areas and pointed by the predetermined touch operation from the display areas that are not failed.

12. The display device according to claim 9, wherein a data line for each display area is driven by a corresponding data Integrated Circuit (IC), a gate line for each display area is driven by a corresponding gate IC, and the image processing module further comprises a switch sub-module configured to, prior to displaying the image to be displayed on the display screen, enable the data ICs and the gate ICs corresponding to the plurality of selected display areas included in the rectangular display area, and disable the other data ICs and gate ICs.

13. The display device according to claim 9, wherein the image processing module comprises:
a selection sub-module configured to select a valid display area including a plurality of adjacent display areas from all the display areas that are not failed; and
a display sub-module configured to display, at the valid display area, the image to be displayed on the display screen.
